(19) United States
(12) Patent Application Publication
(10) Pub. No.: US 2021/0089433 A1
(43) Pub. Date: Mar. 25, 2021

(54) METHOD AND SYSTEM FOR ARTIFICIAL INTELLIGENCE BASED VIDEO GAME TESTING

(71) Applicant: Unity Technologies SF, San Francisco, CA (US)

(72) Inventors: Mohamed Marwan A. Mattar, San Francisco, CA (US); Shuo Diao, Daly City, CA (US); William Harris Kennedy, San Mateo, CA (US); Souranil Sen, San Francisco, CA (US); Jason Aaron Greco, San Francisco, CA (US); Saurabh Dileep Baji, Bothell, WA (US); Danny Lange, Sammamish, WA (US)

(21) Appl. No.: 17/027,604

(22) Filed: Sep. 21, 2020

Related U.S. Application Data
(60) Provisional application No. 62/903,670, filed on Sep. 20, 2019.

(51) Int. Cl. G06F 11/36; G06N 20/00; A63F 13/69

(52) U.S. Cl. CPC G06F 11/3664; G06F 11/3676; A63F 13/69; G06F 11/368; G06N 20/00; G06F 11/3688

(57) ABSTRACT

A method for evaluating a build of a computer-implemented game is disclosed. An evaluation request is received. The evaluation. request includes an identification of the build, data describing one or more behaviors for the build, and data describing one or more tests. One or more simulations of playing of the build are performed using the one or more behaviors. One or more metrics ate extracted from the simulations. Each of the one or more metrics measures an aspect of the computer-implemented game. One or more tests are applied to the one or more metrics to evaluate an adherence of the build to the one or more tests. A display of the evaluation is caused to be displayed in a user interface of a client device.

### CROSS-REFERENCE TO RELATED APPLICATIONS

This application claims the benefit of U.S. Provisional Application No. 62/903,670, filed Sep. 20, 2019, entitled “METHOD AND SYSTEM FOR ARTIFICIAL INTELLIGENCE BASED VIDEO GAME TESTING,” which is incorporated by reference herein in its entirety.

### TECHNICAL FIELD

The subject matter disclosed herein generally relates to the technical field of computer systems, and in one specific example, to computer systems and methods for cloud based testing of video games using simulations.

### BACKGROUND OF THE INVENTION

There is a challenge involved in testing, evaluating and optimizing games (or applications) during a game development process (i.e. pre-launch, before the game is published to players). During the initial development cycle of a game, there are a large number of design decisions that can impact the difficulty, enjoyment and flow of the game. When game developers create new builds or snapshots of a game codebase, there is usually a need to perform thorough testing of the game build, not just for evaluating bugs and crashes, but to ensure that design decisions have not been violated with code changes. One aspect of game testing involves the use of hard-coded scripts fly unit testing. These are typically automated scripts written by the developers themselves. These serve as a form of integration testing for specific parts of a game, but not a full end-to-end test of the entire game.

During the initial development cycle of a game (e.g., prior to the game being released to the public), developers of the game rely on playtests to receive feedback on the game. Playtests are sessions wherein human players are recruited to play the game and provide quantitative feedback on the game. Additionally, quality assurance (QA) teams are employed to test the game (or specific parts of the game) regularly to ensure that bugs (e.g., crashing of the game) have not been introduced by the developers and to evaluate specific design decisions. The feedback from playtesters and the QA team is used to update design and implementation of the game. The updates can include large changes to progression within the game or tuning specific settings of the game to achieve a desired effect.

The use of playtesters and QA testing can be time-consuming and expensive. As such, it is typically employed at the weekly or monthly cadence (e.g., it can take weeks for a game tester to complete playing a game) which can result in a slow iteration cycle for the game.

### BRIEF DESCRIPTION OF THE DRAWINGS

Features and advantages of example embodiments of the present invention will become apparent from the following detailed description, taken in combination with the appended drawings, in which:

FIG. 1 is a schematic illustrating an AI cloud testing system, in accordance with one embodiment;

FIG. 2 is a schematic illustrating a AI cloud testing user device within an AI cloud testing system, in accordance with one embodiment;

FIG. 3 is a schematic illustrating an AI cloud testing server device within an AI cloud testing system, in accordance with one embodiment;

FIG. 4 is a flowchart showing a method for implementing an AI cloud testing system, in accordance with an embodiment;

FIG. 5 is a flowchart illustrating a method for evaluating game parameters against a series of tests within an AI cloud testing system, in accordance with an embodiment;

FIG. 6 is a flowchart illustrating a method for optimizing game parameters within an AI cloud testing system, in accordance with an embodiment;

FIG. 7 is a block diagram illustrating an example software architecture, which may be used in conjunction with various hardware architectures described herein; and

FIG. 8 is a block diagram illustrating components of a machine, according to some example embodiments, configured to read instructions from a machine-readable medium (e.g., a machine-readable storage medium) and perform any one or more of the methodologies discussed herein.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that various embodiments of the inventive subject matter may practiced without these specific details.

The term ‘game’ used throughout the description herein should be understood to include video games and applications that represent video games and applications that represent simulations. The term game should also be understood to include programming code (either source code or executable binary code) which is used to create and execute the game on a device.

The terms ‘build’ and ‘game build’ used throughout the description herein should be understood to include a compiled binary code of a game which can be executed on a device, and which, when executed can provide a playable version of the game (e.g., playable by a human or by an artificial intelligence agent).

The term ‘game parameters’ used throughout the description herein should be understood to include numeric variables within a game which can impact gameplay of the game. For example, a value of player points generated when a player successfully completes a level can affect the gameplay since a large value provides the player more points which may make gameplay on a next level easier. The following are additional examples (non-limiting) of game parameters: a number of coins received by a player when the player achieves a goal in a game, a time a player has to finish a level in a game, a number or lives a player has during game play, a progression counter during a game, a measure of difficulty of game play, and the like.

The term ‘behavior’ used throughout the description herein should be understood to include an entity that can mimic input from a real player (e.g., input including character controls) in order to play a game (or part of a game). For example, the entity may be an artificial intelligence (AI) agent trained via a machine learning model (e.g., created by a game creator) to play a game. As another example, the entity may be an AI agent based on heuristics (e.g., created by a game creator) to play a game. The agent may be trained through a machine learning algorithm (e.g., reinforcement learning, imitation learning, a hybrid method, or the like). The entity is used to perform simulations of the game. A creator of a game may create a large number of behaviors to choose from for different tests. Additionally, the behavior itself may be parameterized (e.g., the behavior may have a number of settings, each of which results in a slightly different behavior). For example, a behavior may include a setting for “aggressiveness” that is to be exhibited by the entity as it plays a game, and which may be associated with a scalar number that ranges from 0 to 1 (e.g., with 0 representing an unaggressive behavior, while 1 represents an aggressive behavior). As another example, a behavior may include a setting for “skill” that is to be exhibited by the entity as it plays a game, and which may be associated with a scalar number that ranges from a low value to a high value (e.g., with the low value representing an unskilled behavior, while the high value represents a highly skilled behavior). As another example, a behavior may include a setting for “speed” that is to be exhibited by the entity as it plays a game, and which may be associated with a scalar number that ranges from a low value to a high value (e.g., with the low value representing a slow reacting behavior, while the high value represents a fast reacting behavior).

The term ‘metrics’ used throughout the description herein should be understood to include numeric valued attributes that are generated when a build runs to completion (e.g., during a simulation). In accordance with an embodiment, metrics represent specific attributes from a build (e.g., a number of obstacles the behavior faced, a length of time for an entire session, and so on). Metrics for a game may be defined by a creator of the game. In accordance with an embodiment, metrics may be grouped into a plurality of types. For example, there may be a Gameplay type metric associated with a measure of a playing of a game; including a measure of whether a player finished a level, a measure of steps taken by a player to complete a level, a measure of a time difference between two players to complete a level, and the like. As another example, there may be an Economy type metric associated with a measure of a game economy; including a measure of points accumulated by a player after finishing each of a first 30 levels in a game (e.g., as a time series), a measure of coins unlocked per level of a game, and the like. As another example, there may be a Functional validation type metric associated with a measure of a proper functioning of a game; including a measure quality assurance to ensure that a game does not contain a bug (e.g., assuring a player account balance can not be negative). As another example, there may be a Performance type metrics associated with a measure of performance of a game; including a measure of CPU use during a playing of a game, a measure of memory use during a playing of a game, and the like.

The term ‘raw metrics’ used throughout the description herein should be understood to include numeric value attributes generated from running a build (e.g., simulating a build using a behavior) for a plurality of times (e.g., across many machines).

The term ‘aggregate metrics’ used throughout the description herein should be understood to include a plurality of raw metrics aggregated across a plurality of simulation runs of a build (e.g., or across a plurality of simulation runs of different builds) using a plurality of aggregation functions (e.g. mathematical functions that include min, max, mean, standard deviations and the like). For example, based on a build being run 100 times, a raw metric from the build can be averaged across the 100 runs to generate one aggregate metric.

The term ‘test’ used throughout the description herein should be understood to include Boolean expressions that operate on aggregate metrics. A test can be a function that accepts as input one or more aggregate metrics and returns either true or false.

The term ‘content’ used throughout the description herein should be understood to include all forms of media including pictures, videos, audio, text, 3d models, 3d playable animations, and the like.

The term ‘environment’ used throughout the description herein is understood to include 2D digital environments (e.g., 2D video game environments, 2D simulation environments, and the like), 3D digital environments (e.g., 3D game environments, 3D simulation environments, 3D content creation environment, virtual reality environments, and the like), and augmented reality environments that include both a digital (e.g., virtual) component and a real-world component.

The term ‘game object’, used throughout the description herein understood to include any digital object or digital element within an environment. A game object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘game object’ may also be understood to include linked groups of individual game objects. A game object is associated with data that defines properties and behavior for the object.

The terms ‘asset’, ‘game asset’, and ‘digital asset’, used throughout the description herein are understood to include any data that can be used to describe a game object or can be used to describe an aspect of a digital project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more game objects within a game at runtime.

The terms ‘client’ and ‘application client’ used throughout the description herein are understood to include a software client or software application that accesses data and services on a server, including accessing over a network.

The term ‘runtime’ used throughout the description herein should be understood to include a time during which a program (e.g., an application, a video game, a simulation, and the like) is running, or executing (e.g., executing programming code). The term should be understood to include a time during which a video game is being played by a human user or played by an artificial intelligence agent.

Throughout the description herein, the term ‘agent’ and ‘AI agent’ should be understood to include entities such as a non-player character (NPC), a robot, and a game world which are controlled by an artificial intelligence system or model.

A method for evaluating a build of a computer-implemented game is disclosed. An evaluation request is received. The evaluation request includes an identification of the build, data describing one or more behaviors for the build, and data describing one or more tests. One or more simulations of playing of the build are performed using the one or more behaviors. One or more metrics are extracted from the simulations. Each of the one or more metrics measures an aspect of the computer-implemented game. One or more tests are applied to the one or more metrics to evaluate an adherence of the build to the one or more tests. A display of the evaluation is caused to be displayed in a user interface of a client device.

In example embodiments, the operations are alternatively for optimizing game parameters of the build of the computer-implemented game. The parameters of the build are updated based on execution of an optimization loop until each of the one or more tests is passed or until a cost budget is reached or exceeded. The execution of the optimization loop includes repeatedly performing at least the following operations: modifying at least one parameter of the one or more game parameters within the build; performing an additional one or more simulations of playing of the modified build using the one or more behaviors; extracting an additional one or more metrics from the simulations, each of the additional one or more metrics measuring an aspect of the computer-implemented game; applying the one or more tests to the additional one or more metrics to evaluate the adherence of the modified build to the one or more tests; and causing a display of results of the optimizing in the user interface of the client device.

The present invention includes apparatuses which perform one or more operations or one or more combinations of operations described herein, including data processing systems which perform these methods and computer readable media which when executed on data processing systems cause the systems to perform these methods, the operations or combinations of operations including non-routine and unconventional operations or combinations of operations.

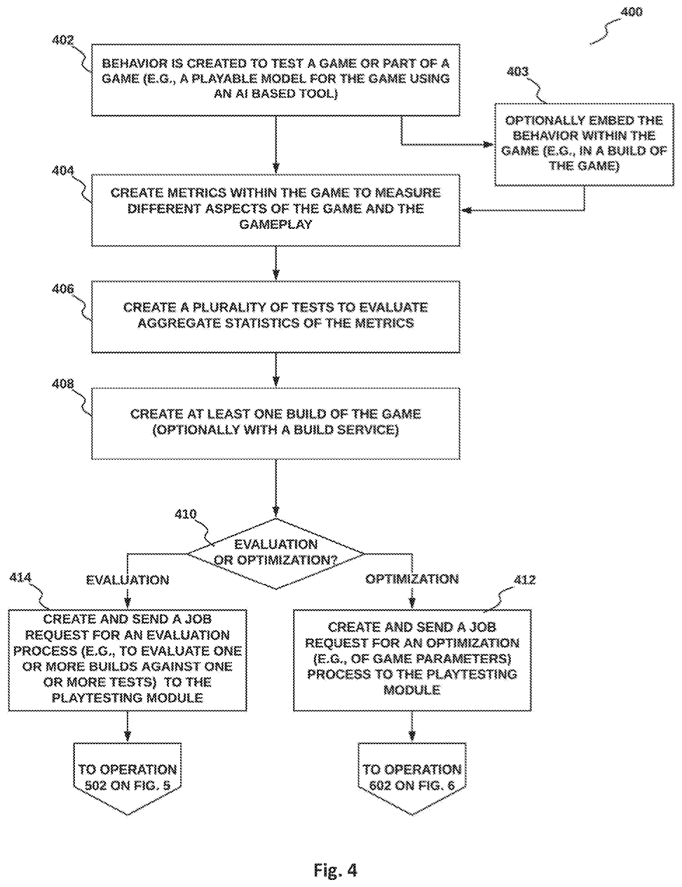

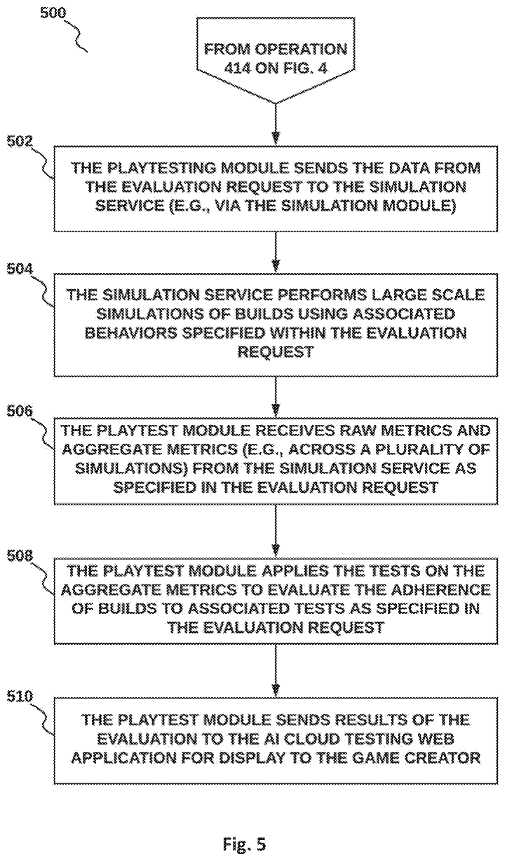

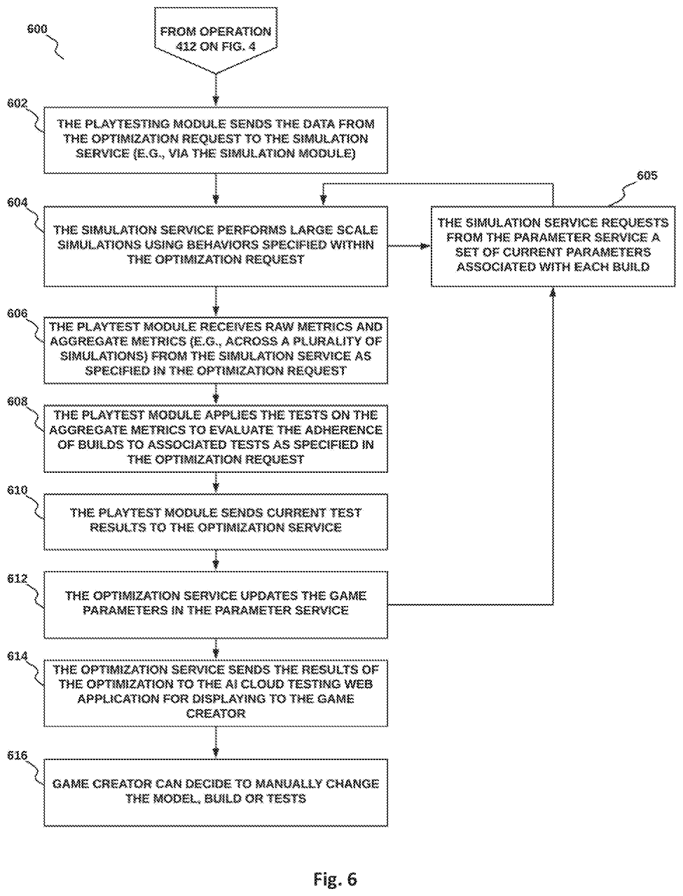

In accordance with an embodiment the AI cloud testing system is beneficial because it enables a creator of a game (e.g., a developer) to test, evaluate and optimize (e.g., as described with respect to FIG. 4, FIG. 5, and FIG. 6) the game in a faster and cheaper fashion when compared to traditional QA and playtests (e.g., automated unit testing, manual game play testing, manual QA testing, and the like). The AI cloud testing system leverages a learned playable model (e.g., a behavior which has been trained) of the game to perform large-scale distributed simulations of the game to evaluate specific tests designed by the game creator. Furthermore, in accordance with an embodiment, the AI cloud testing system can use results of the tests to manipulate aspects of the game on behalf of the game creator (e.g., as described in operations 612, 614 and 616 of the method 600 shown in FIG. 6). In accordance with an embodiment, the AI cloud testing system provides (e.g., via the methods described with respect to FIG. 4, FIG. 5, and FIG. 6) a tight iteration cycle for game creators to ensure that a created game matches design criteria for the game by providing immediate feedback to a game creator via large-scale simulations of the created game. In accordance with an embodiment, as described herein with respect to FIG. 4, FIG. 5, and FIG. 6, the large-scale simulations can be used for at least three benefits: (1) Finding bugs in the created game by discovering paths through the created game that result in crashes; (2) Evaluating game balance aspects of the created game (e.g. determining that two levels are of approximate difficulty); and (3) Optimizing game settings to achieve a desired game balance.

In accordance with an embodiment, another benefit provided by the AI cloud testing system (and the methods described with respect to FIG. 4, FIG. 5, and FIG. 6) is that a game creator can control a quality of simulation results based on a choice of behaviors used during simulation.

In accordance with an embodiment, during operation, real-time feedback for a created game provided by the AI cloud testing system (e.g., using methods described with respect to FIG. 4, FIG. 5, and FIG. 6) can be used by a game creator to quickly iterate on a design and on game mechanics of the created game. Similarly, the real-time feedback of the created game can be integrated (e.g., by a game design studio) into a recurring (e.g., daily/weekly) automated testing pipeline to ensure that newly developed versions of the game do not result in regressions.

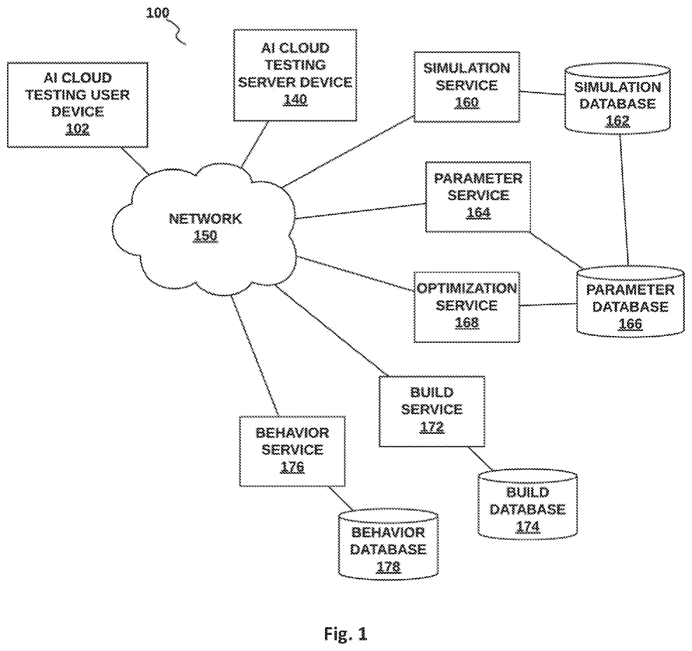

Turning now to the drawings, systems and methods, including non-routine or unconventional components or operations, or combinations of such components or operations, for evaluating and optimizing game parameters using simulation in accordance with embodiments of the invention are illustrated. In accordance with many embodiments, and shown in FIG. 1 is an AI cloud testing system 100. The AI cloud testing system 100 includes an AI cloud testing user device 102, an AI cloud testing server device 140, in networked communication over a network 150. In accordance with an embodiment, the AI cloud testing system 100 also includes a simulation service 160 and simulation database 162 wherein the simulation service 160 may include one or more devices capable of performing simulations (e.g., implementing a behavior to play a game) and the simulation database 162 stores data required by the simulation service 160 and also stores results from the simulation service 160. In accordance with an embodiment, the simulation service 160 may be used to scale up a plurality of builds running on a plurality of machines (e.g., increase a number of simulations running on the simulation service 160). An operation of the simulation service 160 and the simulation database 162 are further detailed within methods described with respect to FIG. 5 and FIG. 6.

In accordance with an embodiment, and also shown in FIG. 1, the AI cloud testing system 100 may also include a parameter service 164 and a parameter database 166, wherein the parameter service 164 may set game parameters associated with each executed build (e.g., each build run by the simulation service 160), and wherein the parameter database 166 may store data associated with parameters (e.g., parameter values determined by the parameter service 164).

In accordance with an embodiment, and also shown in FIG. 1, the AI cloud testing system 100 may also include an optimization service 168, wherein the optimization service 168 may include one or more devices capable of performing optimizations (e.g., updating parameter values from the simulation service 160) as described in detail within the method 600 and shown within FIG. 6. In accordance with an embodiment, the AI cloud testing system 100 may also include a build service 172 and a build database 174, wherein the build service 172 provides tools to manage a plurality of builds which may be stored within the build database 174 as described at least with respect to operation 408 in FIG. 4. In accordance with an embodiment, the AI cloud testing system 100 may also include a behavior service 176 and a behavior database 178, wherein the behavior service 176 provides tools to allow game creators to create, modify and manage behaviors for a game and store the behaviors within the behavior database 178 as described at least with respect to operation 402 in FIG. 4.

In accordance with an embodiment, the behavior service 176, the parameter service 164, the optimization service 168, the simulation service 160, and the build service 172 may each be implemented as an API endpoint, and may also be implemented as a web-application front-end. In accordance with an embodiment, while shown in FIG. 1 as separate devices, the behavior service 176, the parameter service 164, the optimization service 168, the simulation service 160, and the build service 172 may individually or collectively be implemented within the AI cloud testing server device 140.

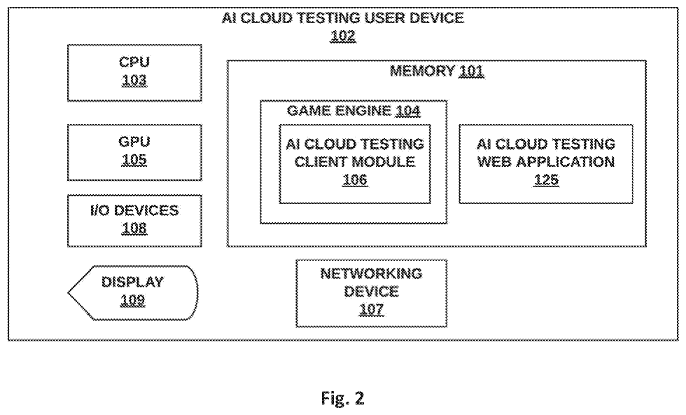

In accordance with an embodiment and shown in FIG. 2 is a schematic showing details of an AI cloud testing user device 102 within an AI cloud testing system 100. The AI cloud testing user device 102 includes one or more central processing units 103 (CPUs), and graphics processing units 105 (GPUs). The CPU 103 (and the GPU 105) is any type of processor, processor assembly comprising multiple processing elements (not shown), having access to a memory 101 to retrieve instructions stored thereon, and execute such instructions. Upon execution of such instructions, the instructions implement the processing device 103 to perform a series of tasks as described below in reference to FIG. 4, FIG. 5 and FIG. 6. The memory 101 can be any type of memory device, such as random access memory, read only or rewritable memory, internal processor caches, and the like.

The AI cloud testing user device 102 may also include one or more input/output devices 108 such as, for example, a keyboard or keypad, mouse, pointing device, touchscreen, microphone, camera, and the like, for inputting information in the form of a data signal readable by the processing device 103. The AI cloud testing user device 102 further includes one or more display devices 109, such as a computer monitor, a touchscreen, and a head mounted display (HMD), which may be configured to display digital content including video, a video game environment, an integrated development environment and a virtual simulation environment to a game creator. The display device 109 is driven or controlled by the one or more GPUs 105 and optionally the CPU 103. The GPU 105 processes aspects of graphical output that assists in speeding up rendering of output through the display device 109. The AI cloud testing user device 102 also includes one or more networking devices 107 (e.g., wired or wireless network adapters) for communicating across the network 150.

In accordance with an embodiment, the memory 101 on the AI cloud testing user device 102 may also store a game engine 104 (e.g., executed by the CPU 103 or GPU 105) that communicates with the display device 109 and also with other hardware such as the input/output device(s) 108 to present a 3D game environment (e.g., a video game) and a 3D game development environment (e.g., an integrated development environment (IDE)) to a game creator. The game engine 104 may include one or more modules that provide the following: animation physics for game objects, collision detection for game objects, rendering, networking, sound, animation, and the like in order to provide a game creator with a video game (or simulation) environment.

In accordance with an embodiment, the memory 101 on the AI cloud testing user device 102 also stores an AI cloud testing client module 106 for implementing methods as described herein and in particular with respect to the methods shown in FIG. 4, FIG. 5 and FIG. 6. The AI cloud testing client module 106 may be implemented for example as a software development kit (SDK). In accordance with an embodiment, the AI cloud testing client module 106 may be implemented as a separate module from the game engine 104. In accordance with an embodiment, the memory 101 on the AI cloud testing user device 102 may also store an AI cloud testing web application 125 for creating, displaying and manipulating at least models, builds, and tests as described herein and in particular with respect to the methods shown in FIG. 4 (e.g., operations 406 and 408), FIG. 5 and FIG. 6 (e.g., operations 614 and 616).

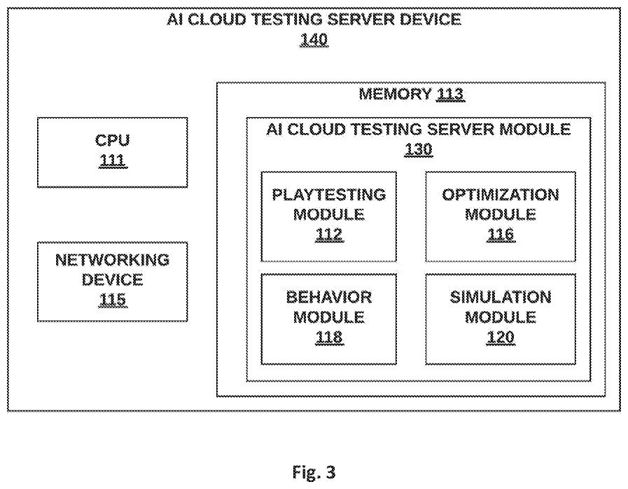

In accordance with an embodiment and shown in FIG. 3 is an AI cloud testing server device 140. The AI cloud testing server device 140 includes one or more central processing units 111 (CPUs). The CPU 111 may be any type of processor, processor assembly comprising multiple processing elements (not shown), having access to a memory 113 to retrieve instructions stored thereon, and execute such instructions. Upon execution of such instructions, the instructions implement the processing device 111 to perform a series of tasks as described below in reference to FIG. 4, FIG. 5 and FIG. 6. The memory 113 can be any type of memory device, such as random access memory, read only or rewritable memory, internal processor caches, and the like. The AI cloud testing server device 140 also includes one or more networking devices 115 (e.g., wired or wireless network adapters) for communicating across the network 150.

In accordance with an embodiment, the memory 113 on the AI cloud testing server device 140 may store a playtesting module 112 for implementing methods as described herein with respect to a playtesting module, and in particular with respect to the methods shown in FIG. 4, FIG. 5 and FIG. 6. In accordance with an embodiment, the memory 113 on the AI cloud testing server device 140 also stores an optimization module 116 for implementing methods as described herein with respect to an optimization module 116 and in particular with respect to the method described in FIG. 4 and FIG. 6. In accordance with an embodiment, the optimization module 116 may train and implement a machine learning model (or may apply rules) to intelligently select game parameter values from the parameter service 164 (or from the parameter database 166) in order to generate successful results for tests (e.g., as described in operations 605, 608, 610 and 612 of the method 600 shown in FIG. 6). In accordance with an embodiment, the optimization module 116 may train and implement a machine learning model (or may apply rules) to intelligently generate game parameter values for the parameter service 164 (or for the parameter database 166) in order to generate successful results for tests (e.g., as described in operations 605, 608, 610 and 612 of the method 600 shown in FIG. 6). In accordance with an embodiment, the optimization module 116 may communicate with the optimization service 168. While the optimization service 168 is shown separately from the AI cloud testing server device 140 in FIG. 1, in some implementations of the AI cloud testing system 100, the optimization service 168 may be implemented within the optimization module 116.

In accordance with an embodiment, the memory 113 on the AI cloud testing server device 140 also stores a behavior module 118 for implementing methods as described herein with respect to a behavior module 118, and in particular with respect to the method described in FIG. 4, FIG. 5 and FIG. 6. In. accordance with an embodiment, the behavior module 118 may communicate with the behavior service 176 and the behavior database 178. While the behavior service 176 is shown separately from the AI cloud testing server device 140 in FIG. 1, in some implementations of the AI cloud testing system 100, the behavior service 176 may be implemented within the behavior module 118.

In accordance with an embodiment, the memory 113 on the AI cloud testing server device 140 also stores a simulation module 120 for implementing methods as described herein with respect to a simulation module 120, and in particular with respect to the method described in FIG. 4, FIG. 5 and FIG. 6. In accordance with an embodiment, the simulation module 120 may communicate with the simulation service 160 and the simulation database 162. While the simulation service 160 is shown separately from the AI cloud testing server device 140 in FIG. 1, in some implementations of the AI cloud testing system 100, the simulation service 160 may be implemented within the simulation module 120.

While the build service 172 is shown separately from the AI cloud testing server device 140 in FIG. 1, in some implementations of the AI cloud testing system. 100, the build service 172 may be implemented within the AI cloud testing server module 130.

In accordance with an embodiment, the AI cloud testing client module may be implemented within a software development kit (SDK) that enables a game creator to implement metrics within a game, in addition to implementing game parameters within the game. In accordance with an embodiment, game parameters can be remotely configured (e.g., using methods described with respect to FIG. 4, FIG. 5, and FIG. 6) whereby the values of the game parameters can be modified outside of a build.

In accordance with an embodiment and shown in FIG. 4, there is provided a method 400 for implementing an AI cloud testing system 100. At operation 402 of the method 400, a behavior is created to test a game (or part of a game). As part of operation 402, the behavior may be received by the AI cloud testing client module 106 or the AI cloud testing server module. For example, a game creator may create a playable model (e.g., as a behavior) for the game using an AI based tool for creating behaviors. In accordance with an embodiment, the AI based tool may be the AI cloud testing web application 125. In accordance with an embodiment, at operation 403 of the method 400, the behavior may optionally be embedded within the game (e.g., the behavior may be included within game code and packaged. within a build of the game as described below with respect to operation 408). In accordance with an embodiment, at operation 404 of the method 400, one or more metrics may be created and placed within the game (e.g., placed within game code that is executed during a runtime of the game), whereby the one or more metrics measure different aspects of the game during gameplay (e.g., during a runtime while the game is being played by a behavior). In accordance with an embodiment, each metric of the one or more metrics may measure one or more aspects of the game. In accordance with an embodiment, a metric may be created by a game creator. In accordance with an embodiment, at operation 406 of the method 400, a plurality of tests is created for the game (e.g., created by the game creator). Each test of the plurality of tests evaluates aggregate statistics of the one or more metrics. In accordance with an embodiment, the one or more metrics and the plurality of tests may be created with an AI cloud testing web application 125 (e.g., by a game creator). In accordance with an embodiment, at operation 408 of the method 400, at least one build of the game is created (e.g., optionally with the build service 172). As part of operation 408, the at least one build may be created by the game creator. At 410 of the method 400, a decision is made to either evaluate one or more builds against the tests (e.g., from operation 406) or optimize game parameters for one or more builds. In accordance with an embodiment, the decision may be made based on a receiving of instructions via an input device 108 (e.g., received via the AI cloud testing web application 125). In accordance with an embodiment, at operation 414 of the method 400, based on a decision to evaluate, an evaluation. request is sent from the AI cloud testing client module 106 to the AI cloud testing server module 130 (e.g., to the playtesting module 112) to request an evaluation. In accordance with an embodiment, the evaluation request includes data describing details of performing the evaluation (e.g., as a plurality of jobs). In accordance with an embodiment, the evaluation request includes data describing a build to evaluate (or a plurality of builds to evaluate), data describing one or more behaviors for each build, data describing tests (including aggregates) to run on each simulation for each build, and a value for the number of times to run simulations for each behavior. The evaluation from operation 414 is further described with respect to the method shown in FIG. 5 starting with operation 502.

In accordance with an embodiment, at operation 412 of the method 400, based on a decision to optimize, an optimization request is sent from the AI cloud testing client module 106 to the AI cloud testing server module 130 (e.g., to the playtesting module 112) to request an optimization. In accordance with an embodiment, the optimization request includes data describing details of performing the optimization (e.g., as a plurality of jobs). In accordance with an embodiment, the optimization request includes data describing a build to optimize (or a plurality of builds to optimize), data describing one or more behaviors for each build (e.g., behaviors to be applied to the builds), data describing tests (including aggregates) to run on each simulation, a value for the number of times to run simulations for each behavior, and an allowed range of game parameters for the simulations (e.g., wherein the game parameters can be remotely configurable within a build). The optimization of operation 412 is further described with respect to the method shown in FIG. 6 starting with operation 602.

In accordance with an embodiment and shown in FIG. 5, there is provided a method 500 to be used with an AI cloud testing system 100 for performing an evaluation session. (e.g., continuing from operation 414). In accordance with an embodiment, an evaluation session includes receiving (e.g., from a game creator) an evaluation request that includes data describing a build, a behavior (or number of behaviors), a collection of tests, an integer representing the number of simulations for each build and each behavior and wherein the session generates (and possibly returns to the AI cloud testing client module 106) results from performing the tests (e.g., including running simulations, generating raw metrics, generating aggregate metrics and performing tests on the aggregate metrics). In accordance with an embodiment, at operation 502 of the method 500, the playtesting module 112 sends the data from the evaluation request to the simulation service 160 (e.g., via the simulation module 120). In accordance with an embodiment, at operation 504 of the method 500, the simulation service 160 performs large scale simulations of builds using associated behaviors specified within the evaluation request. Accordingly, as part of operation 504, each build specified in the evaluation request is simulated with a plurality of behaviors as specified in the evaluation request and for a number of times as specified within the evaluation request. Each build within the evaluation request may be associated with different behaviors. In accordance with an embodiment, at operation 506 of the method 500, the playtest module 112 receives raw metrics (e.g., from each simulation of each build) and aggregate metrics (e.g., aggregated across a plurality of simulations) from the simulation service 160 as specified in the evaluation request. For example, the evaluation request may specify a list of raw metrics and a list of aggregate metrics to be returned to the playtest module 112. In accordance with an embodiment, at operation 508 of the method 500, the playtest module 112 applies the tests (e.g., as specified in the evaluation request) to the aggregate metrics in order to evaluate an adherence of builds to the associated tests. The evaluation request may specify one or more tests (e.g., Boolean tests) for each of the received aggregate metrics (e.g., from operation 506). The evaluation request may also specify one or more tests to be applied to the raw metrics. In accordance with an embodiment, at operation 510 of the method 500, the playtest module 112 sends results of the evaluation. to the AI cloud testing web application 125 for display (e.g., to the game creator via a display device 109). The evaluation results may include the received raw metrics (e.g., from operation. 506), the received aggregate metrics (e.g., from operation 506), and the test results (e.g., from operation 508). An entity (e.g., the game creator or an AI) may use the displayed test results to determine modifications for a plurality of elements associated with the game in order to change future results, including: modifying game parameters within a game, modifying behaviors (e.g., by re-training a model), modifying builds (e.g., by changing a game codebase), and modifying tests (e.g., by updating tests via the AI cloud testing web application 125). The modifications may be performed as part of operations 402, 404, 406, and 408 of the method 400 (e.g., by the game creator) prior to submitting a new evaluation request at operation. 414 (e.g., via the AI cloud testing web application 125).

In accordance with an embodiment and shown in FIG. 6, there is provided a method 600 to be used with an AI cloud testing system 100 for optimizing one or more game parameters for a build (or a plurality of builds) within an optimization session. In accordance with an embodiment, an optimization session uses input similar to an evaluation session, with the addition of a description of a number of game parameters and ranges for values of the game parameters, and a cost budget (e.g., to control or limit the optimization). In accordance with an embodiment, at operation 602 of the method 600, the playtesting module 112 sends the data from within the optimization request to the simulation service 160 (e.g., via the simulation module 120). In accordance with an embodiment, at operation 604 of the method 600, the simulation service 160 performs large scale simulations using behaviors specified with the optimization request. Accordingly, each build specified in the optimization request is simulated with a plurality of behaviors as specified in the optimization request and for a number of times as specified within the optimization request. Each build within the optimization request may be associated with different behaviors. In accordance with an embodiment, at operation 605 of the method 600, the simulation service 160 requests from the parameter service 164 a set of current parameters associated with each. build (e.g., in order to have an up to date set of parameters). The game parameters within the parameter service 164 may be modified by the optimization service 168 (e.g., as described with respect to operation 612). In accordance with an embodiment, operation 605 is performed prior to every simulation. (e.g., in order to perform the simulation with a current set of game parameters). In accordance with an embodiment, at operation 606 of the method, the playtest module 112 receives raw metrics (e.g., from each simulation of each build) and aggregate metrics (e.g., aggregated across a plurality of simulations) from the simulation service 160 as specified in the optimization request. For example, the optimization request may specify a list of raw metrics and a list of aggregate metrics to be returned to the playtest module 112. In accordance with an embodiment, at operation 608 of the method 600, the playtest module 112 applies the tests as specified in the optimization request on the aggregate metrics to evaluate the adherence of builds to the associated tests. The optimization request specifies one or more tests (e.g., Boolean tests) for each of the aggregate metrics. The optimization request may also specify one or more tests to be applied to the raw metrics. In accordance with an embodiment, at operation 610 of the method, the playtest module 112 sends test results to the optimization service 168. In accordance with an embodiment, at operation 612 of the method 600, the optimization service updates the game parameters in the parameter service (as described in operation 605). In accordance with an embodiment, at operation 614 of the method 600, the optimization service 168 sends the results of the optimization to the AI cloud testing web application 125 (or the AI cloud testing client module 106) for displaying to the game creator. In accordance with an embodiment, at operation 616 of the method 600, an entity (e.g., the game creator or an AI) can decide to change a plurality of elements, including: game parameters within a game, behaviors (e.g., by re-training a model), builds (e.g., by changing a game codebase), and tests (e.g., by updating them via the AI cloud testing web application 125). The game creator would then submit a new job request (e.g., via the AI cloud testing web application). In accordance with an embodiment, the optimization loop including operations 604, 605, 606, 608, 610 and 612 are performed until a set of values for the game parameters are found such that the tests are true (e.g., passed) when using the found set of values or until a cost of the parameter search loop is above the cost budget. In accordance with an embodiment, if no set of values for the game parameters exists (or is found) that make the tests true, then the session may return a setting that makes an optimum number of tests true.

In accordance with an embodiment, the AI cloud testing web application 125 can receive from a game creator a list of predefined tests to be applied to a specific build. The AI cloud testing web application 125 can be configured to delver notifications when a build (e.g., a new build) violates the pre-defined tests.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawing are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

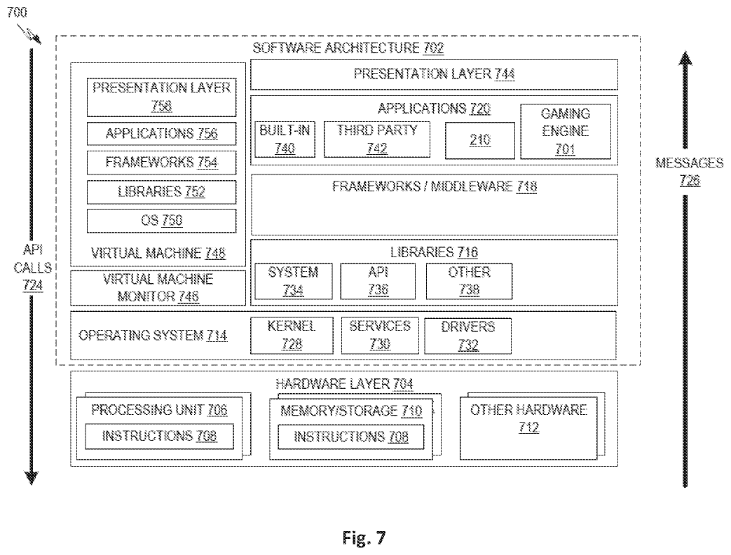

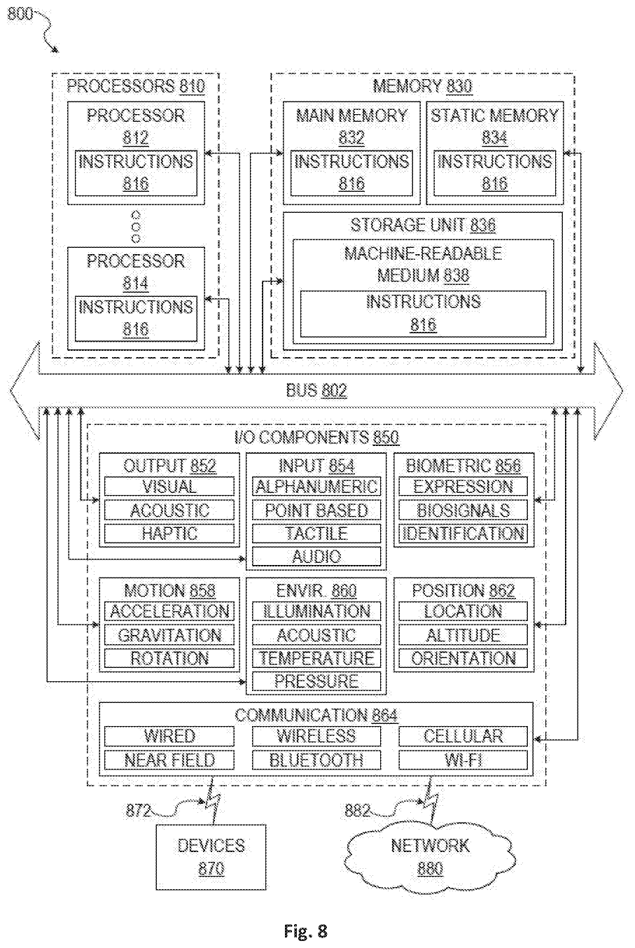

FIG. 7 is a block diagram 700 illustrating an example software architecture 702, which may be used in conjunction with various hardware architectures herein described to provide a gaming engine 701 and/or components of the AI cloud testing system 100. FIG. 7 is a non-limiting example of a software architecture and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 7, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/ module “logic” can be separated from the aspects of the application/module that interact with a user.

Some software architectures use virtual machines. In the example of FIG. 7, this is illustrated by a virtual machine 748. The virtual machine 748 creates a software environment where applications/modules can execute as if they were executing on a hardware machine (such as the machine 800 of FIG. 8, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 8 is a block diagram illustrating components of a machine 800, according to some example embodiments, configured to read instructions from a machine-readable medium (e.g., a machine-readable storage medium) and perform any one or more of the methodologies discussed herein. In some embodiments, the machine 110 is similar to the HMD 102. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled. (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), Radio-Frequency Integrated Circuit (RFIC), another processor, or any suitable combination thereof) may include, for example, a processor 812 and a processor 814 that may execute the instructions 816. The term. “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more or the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 8. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that, detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection. components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

I/we claim:

1. A system comprising:
one or more computer processors;
one or more computer memories;
a set of instructions incorporated into the one or more computer memories, the set of instructions configuring the one or more computer processors to perform operations for evaluating a build of a computer-implemented game, the operations comprising:
receiving an evaluation request, the evaluation request including an identification of the build, data describing one or more behaviors for the build, and data describing one or more tests;
performing one or more simulations of playing of the build using the one or more behaviors;
extracting one or more metrics from the simulations, each of the one or more metrics measuring an aspect of the computer-implemented game;
applying the one or more tests to the one or more metrics to evaluate an adherence of the build to the one or more tests; and
causing a display of the evaluation in a user interface of a client device.

2. The system of claim 1, the operations alternatively being for optimizing game parameters of the build of the computer-implemented game, the operations further comprising:
updating the parameters of the build based on execution of an optimization loop until each of the one or more tests is passed or until a cost budget is reached or exceeded; and
causing a display of results of the optimizing in the user interface of the client device.

3. The system of claim 2, wherein the execution of the optimization loop includes, at least, repeatedly performing the following operations:
modifying at least one parameter of the one or more game parameters within the build;
performing an additional one or more simulations of playing of the modified build using the one or more behaviors;
extracting an additional one or more metrics from the simulations, each of the additional one or more metrics measuring an aspect of the computer-implemented. game; and
applying the one or more tests to the additional one or more metrics to evaluate the adherence of the modified build to the one or more tests.

4. The system of claim 3, wherein a selection of the at least one parameter and a range for the modification of the at least one parameter is specified within the request.

5. The system of claim 1, wherein the behavior includes an artificial intelligence agent trained via a machine learning model to play the computer-implemented game.

6. The system of claim 5, wherein the model is parametrized to control the playing of the computer-implemented game and wherein the request may include a specification of the parametrization.

7. The system of claim 1, further including a testing server device, and wherein the operations further include:
sending the request over a network to the testing server device; and
receiving data pertaining to results of the simulations, the extracting of the values, and the applying of the tests from the testing server device, the simulations, the extracting of the values of the metrics, and the applying of the tests being performed on the server device.

8. The system of claim 1, wherein there are plurality of different builds of the computer-implemented game specified in the request, and wherein the metrics generated for each different build of the plurality of different builds are aggregated using a plurality of aggregation functions.

9. The system of claim 1, wherein the operations include:
providing a graphical user interface for display on a display device, the graphical user interface comprising a display area that includes tools for connecting to a behavior management service for generating, training and modifying a behavior.

10. A non-transitory computer-readable storage medium comprising a set of instructions that, when executed by one or more computer processors, causes the one or more computer processors to perform operations for evaluating a build of a computer-implemented game, the operations comprising:
receiving an evaluation request, the evaluation request including an identification of the build, data describing one or more behaviors for the build, and data describing one or more tests;
performing one or more simulations of playing of the build using the one or more behaviors;
extracting one or more metrics from the simulations, each of the one or more metrics measuring an aspect of the computer-implemented game;
applying the one or more tests to the one or more metrics to evaluate an adherence of the build to the one or more tests; and
causing a display of the evaluation in a user interface of a client device.

11. The non-transitory computer-readable medium of claim 10, the operations alternatively being for optimizing game parameters of the build of the computer-implemented game, the operations further comprising:
updating the parameters of the build based on execution of an optimization loop until each of the one or more tests is passed or until a cost budget is reached or exceeded; and
causing a display of results of the optimizing in the user interface of the client device.

12. The non-transitory computer-readable medium of claim 11, wherein the execution of the optimization loop includes, at least, repeatedly performing the following operations:
modifying at least one parameter of the one or more game parameters within the build;
performing an additional one or more simulations of playing of the modified build using the one or more behaviors;
extracting an additional one or more metrics from the simulations, each of the additional one or more metrics measuring an aspect of the computer-implemented game; and
applying the one or more tests to the additional one or more metrics to evaluate the adherence of the modified build to the one or more tests.

13. The non-transitory computer-readable medium of claim 12, wherein a selection of the at least one parameter and a range for the modification of the at least one parameter is specified within the request.

14. The non-transitory computer-readable medium of claim 10, wherein the behavior includes an artificial intelligence agent trained via a machine learning model to play the computer-implemented game.

15. The non-transitory computer-readable medium of claim 10, wherein the model is parametrized to control the playing of the computer-implemented game and wherein the request may include a specification of the parametrization.

16. The non-transitory computer-readable medium of claim 10, further including a testing server device, and wherein the operations further include:
sending the request over a network to the testing server device; and
receiving data pertaining to results of the simulations, the extracting of the values, and the applying of the tests from the testing server device, the simulations, the extracting of the values of the metrics, and the applying of the tests being performed on the server device.

17. The non-transitory computer-readable medium of claim 10, wherein there are plurality of different builds of the computer-implemented game specified in the request, and wherein the metrics generated for each different build of the plurality of different builds are aggregated using a plurality of aggregation functions.

18. The non-transitory computer-readable medium of claim 10, wherein the operations include:
providing a graphical user interface for display on a display device, the graphical user interface comprising a display area that includes tools for connecting to a behavior management service for generating, training and modifying a behavior.

19. A method comprising:
performing operations, using one or more computer processors, for evaluating a build of a computer-implemented game, the operations comprising:
receiving an evaluation request, the evaluation request including an identification of the build, data describing one or more behaviors for the build, and data describing one or more tests;
performing one or more simulations of playing of the build using the one or more behaviors;
extracting one or more metrics from the simulations, each of the one or more metrics measuring an aspect of the computer-implemented game;
applying the one or more tests to the one or more metrics to evaluate an adherence of the build to the one or more tests; and
causing a display of the evaluation in a user interface of a client device.

20. The method of claim 19, wherein the operations are alternatively for optimizing game parameters of the build of the computer-implemented game, the operations further comprising:
updating the parameters of the build based on execution of an optimization loop until each of the one or more tests is passed or until a cost budget is reached or exceeded, the execution of the optimization loop including repeatedly performing, at least, the following operations:
modifying at least one parameter of the one or more game parameters within the build;
performing an additional one or more simulations of playing of the modified build using the one or more behaviors;
extracting an additional one or more metrics from the simulations, each of the additional one or more metrics measuring an aspect of the computer-implemented game; and
applying the one or more tests to the additional one or more metrics to evaluate the adherence of the modified build to the one or more tests; and
causing a display of results of the optimizing in the user interface of the client device.
